(19) United States
(12) Patent Application Publication
(10) Pub. No.: US 2008/0035217 A1
(43) Pub. Date: Feb. 14, 2008

(54) Method and Apparatus for Controlled Mixing of a Dry Material with a Binder

(75) Inventors: Gary Hartman, Hollister, CA (US); Reinerus Cornelis Wilhelmus van den Ende, Honselersdijk (NL); Gerrit Dijkstra, Elysburg, PA (US)

Correspondence Address: CENTRAL COAST PATENT AGENCY, INC, 3 HANGAR WAY SUITE D, WATSONVILLE, CA, 95076, US

(73) Assignee: INTERNATIONAL HORTICULTURAL TECHNOLOGIES, LLC, Hollister, CA (US)

(21) Appl. No.: 11/776,105

(22) Filed: Jul. 11, 2007

Related U.S. Application Data
(60) Provisional application No. 60/837,674, filed on Aug. 14, 2006.

(51) Int. Cl. B01F 13/10

(52) U.S. Cl. 137/560; 366/132; 366/133; 366/134

(57) ABSTRACT

A system for mixing together a dry material and a liquid binder has a first mixing device for mixing the liquid binder with a fluid and a second mixing device for mixing the resulting mixture mixed by the first mixing device with the dry material.

### CROSS-REFERENCE TO RELATED APPLICATIONS

The present invention claims priority to a U.S. provisional patent application Ser. No. 60/837,674 entitled “Method and Apparatus for Mixing Dry Materials with Binders”, filed on Aug. 14, 2006, disclosure of which is included herein at least by reference.

### BACKGROUND OF THE INVENTION

1. Field of the Invention

The present invention is in the area of mixing for producing bulk materials for various purposes from dry, granular precursor material, such as peat moss, ground rubber, ground plastics, and the like, and pertains in one embodiment to producing self-supporting plugs for seed starter cells for transplanting.

2. Discussion of the State of the Art

It is well known that there are many, commercial processes in which substantially granular dry materials are mixed with a binder to form a malleable, formable mix that can be shaped in a number of ways that will become self-supporting when the binder dries or cures. The inventor is aware of such processes that are used to create a variety of end products. There are in many cases serious problems in providing homogeneous mixing of such materials, and a method and apparatus that works well, reliably, and repeatedly is a serious need in industries that rely on such technology.

In a prior art system known to the inventor, and the subject of a U.S. Pat. No. 5,332,309 to Ramazotti, and assigned to Edge-Sweets Company of Grand Rapids, Mich., dry material is fed by an auger to a mixer where water and binder are directly introduced. The inventor believes this system produces material from the mixer that is not thoroughly mixed, for a variety of reasons, one of which is that dry materials that are lighter than water and dry materials that do not readily absorb or adsorb water behave in the mixing chamber in a way that prevents or retards thorough mixing. Very light materials, like expanded polystyrene (EPS), for example, will rise quickly in a watery environment rather than dispersing throughout. Also, in cases where the binder and water or solvents do not produce foaming, injecting the binder and water or solvent directly into the final mixing chamber without pre-mixing also produces sub-par results.

It has occurred to the inventor that different consistencies and characteristics may be achieved in a product using a continuous process where more control is afforded to separate mixing aspects of the materials under varying pressures, feed rates, and temperatures. Therefore, what is needed in the art is a method and system for producing a malleable and formable mixture from dry materials and a binder material.

### SUMMARY OF THE INVENTION

According to an embodiment of the present invention, a system is provided for mixing together a dry material and a liquid binder. The system includes a first mixing device for mixing the liquid binder with a fluid, and a second mixing device for mixing the resulting mixture mixed by the first mixing device with the dry material. In a preferred embodiment, the first mixing device is a variable speed pin mixer having a mixing chamber and a rotable shaft with mixing pins attached thereto. Also in a preferred embodiment, the second mixing device is a linear mixer having a mixing chamber and a rotable shaft with mixing paddles attached thereto.

In one embodiment, the liquid binder is a polymer-based binder including a foaming agent. In one embodiment, the dry material is a granular material mixed with a filler material. In a preferred embodiment, the dry material and binder mixture are introduced to the second mixing device simultaneously and continuously during system run time.

In one embodiment, the system further includes an automatic feed bin having a rotable auger disposed therein for feeding the dry material into the second mixing device. In one embodiment, the system further includes a control station for controlling the speeds of the first mixing device and the second mixing device. In a variation of this embodiment, the system further includes a first source tank for storing the liquid binder and a first pump controllable at the control station for pumping the liquid binder out of the first source tank into the first mixing device. According to this variant, the system further includes a second source tank for storing the fluid and a second pump controllable at the control station for pumping the fluid out of the second source tank into the first mixing device.

According to another variant of this embodiment, the system further includes a source bin for storing the dry material and a conveyor system controllable at the control station for conveying the dry material from the source bin to the automatic feed bin.

According to another aspect of the present invention, a method for mixing a dry material with a liquid binder is provided. The method includes acts for (a) pumping the liquid binder and a fluid from separate source tanks into a first mixing device, (b) mixing the liquid binder and fluid within the first mixing device, (c) feeding the dry material and injecting the premixed binder into a second mixing device, and (d) mixing the dry material and the premixed binder within the second mixing device.

In one aspect of the method, in act (a), the liquid binder is a polymer and the fluid is water. In a variation of this aspect, the liquid binder includes a foaming agent. In a preferred aspect, in act (b), the first mixing device is a pin mixer. In one aspect, in act (a), the liquid binder is temperature controlled. Also in one aspect, in act (b), the speed of mixing and the pressure within the mixer is controllable at a control station.

In one aspect, in act (c), the premixed binder is foam. In one aspect, in act (c), the dry material is fed into the second mixer from an auto feed bin by an auger. In a variation of this aspect, in act (c) the rate of feed of the dry material is controllable at a control station.

### BRIEF DESCRIPTION OF THE DRAWING FIGURES

FIG. 1 is an architectural overview of a continuous mixing system including mixing apparatus for mixing dry materials with a binder according to an embodiment of the present invention.

FIG. 2 is an architectural overview of a conveyor system for staging containers for filling of mixture according to an embodiment of the present invention.

FIG. 3 is a flow chart illustrating steps for mixing ingredients according to an embodiment of the present invention.

FIG. 4 is a process flow chart for varying malleability of mixed product according to an embodiment of the present invention.

### DETAILED DESCRIPTION

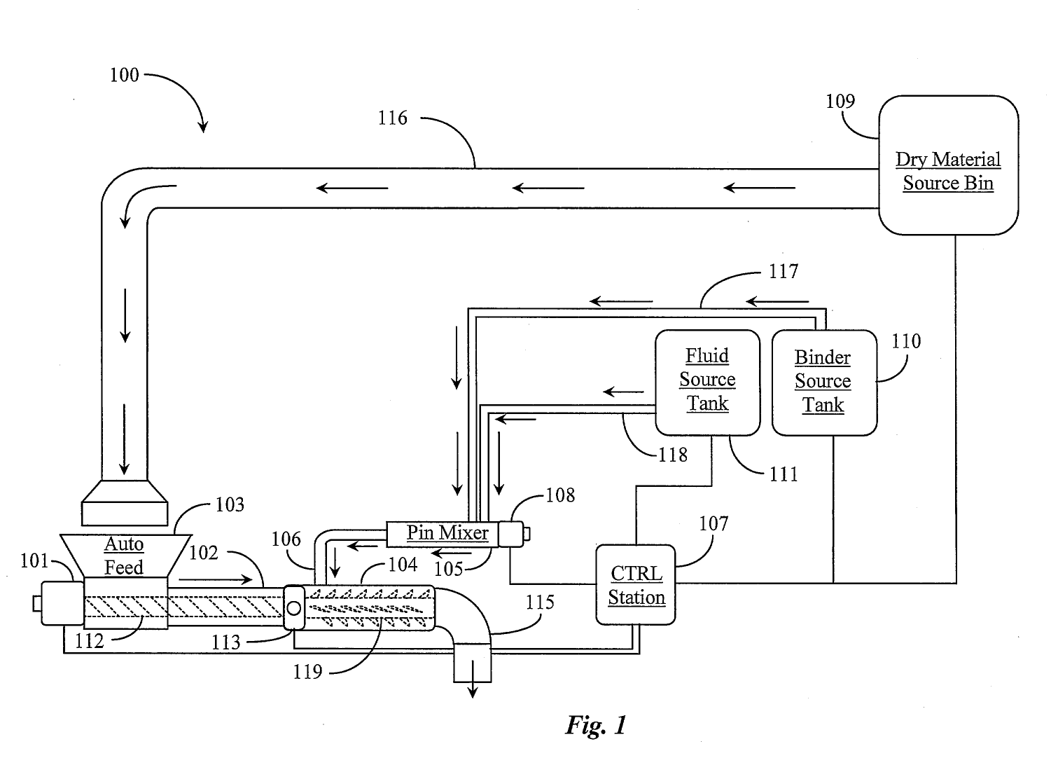

FIG. 1 is an architectural overview of a continuous mixing system 100 including mixing apparatus for mixing dry materials with a binder according to an embodiment of the present invention. System 100 is adapted in this example as a continuous feed mixing system that produces a product that can have varying characteristics according to controllable aspects of the system. In this embodiment, system 100 incorporates a dry, granular material, a reactant fluid and a liquid binder substance to produce a malleable product that may cure to a solid or semi-solid homogeneous form. In this particular embodiment, system 100 is adapted to produce seed plug material used in agriculture. However, that should not be construed as a limitation of the present invention, as system 100 could be adapted to producing other mixed products used in other industries without departing from the spirit and scope of the present invention. One such mixed product might be fire retardant foam. Another mixed product might be a crumb rubber mixture molded into a specific shape or form. There are many other possibilities.

System 100 includes a dry material source bin 109 that is maintained with enough dry material to ensure continuous operation once the mixing system is started. Source bin 109 may be a large metallic container or a container fabricated from polymer or some other impermeable material. Dry material in various embodiments may vary, and in one embodiment is dry material as appropriately used in producing seed plugs.

In this application the dry material is a pre-mixed product that may be purchased for agricultural use. However, in one embodiment, there may be a premixing operation (not illustrated) that mixes dry materials before placement of the mixed material into bin 109. In still another embodiment, there may be more than one source bin for dry materials and a mixing chamber provided to system 100 for mixing the dry materials from the separate source bins in the correct amounts to produce the dry mixed material used in producing the seed plugs in this example. In this example, a dry material product is readily available to the inventor and is convenient to use in the present embodiment such that an additional mixer for mixing dry materials is not required.

A dry materials conveyor system 116 is provided to carry the dry material from source bin 109 to an auto feed bin 103. Conveyor 116 is logically illustrated herein, however in actual practice; conveyor 116 has a carriage, one or more conveyor belts and a motor for activating the system. A portion of conveyor 116 is submerged beneath the dry material in bin 109 so that material is continuously urged onto conveyor 116 toward dry feed bin 103. Bin 109 need only be kept at a level above the conveyor head, (not shown). Other automated feed methods may be used to convey dry materials from bin 109 to auto feed bin 103 without departing from the spirit and scope of the present invention. There are a variety of types and designs for conveyor systems, which any number of or combination of may be incorporated in this embodiment without departing from the spirit and scope of the present invention.

System 100 includes a source tank 110 for storing a binder material. The binder material in this example is a polymer-based material; however, other binder material types like resins, for example, might also be used in some embodiments. In this example, the binder is in the form of a liquid having a low enough viscosity to flow through a delivery line 117. The binder in tank 110 may be kept in a low viscous state by heating in one embodiment. In another embodiment, the binder is naturally fluid when not exposed to air and requires no heat to remain in a state of suitable viscosity. Tank 110 may be assumed to be associated with a pump and motor for pumping the binder out of the tank through line 117 and, in some embodiments, a heating element or elements for maintaining a certain temperature within tank 110. Tank 110 may be provided in a variedly of impermeable materials that can withstand relatively high temperature including steel or glass. In some embodiments line 117 may be temperature-controlled as well.

System 100 includes a fluid source tank 111 within which a fluid is stored for eventual mixing with the binder. In this particular example, the fluid is water. However, in other embodiments other fluid types and mixes might be used depending upon the desired results. Tank 111 may be a steel tank or a glass tank or a tank provided in some other impermeable material. Tank 111 may also be assumed to be associated with a pump and motor for pumping water out from tank 111 through a water line 118. It may be assumed in this example that both tanks 110 and 111 are maintained under a constant pressure so that water and binder liquid are both delivered on a continuous flow when system 100 is running. Tank 111 may also include one or more heating elements for heating the water contained therein and in some cases line 118 may be temperature-controlled as well.

System 100 includes a computerized control (CTRL) station 107 with an operator control interface (not illustrated) adapted to enable operator control of various system components of system 100. In this example, control station 107 has logical control lines to dry material bin 109, binder source tank 110 and fluid source tank 111. The aspects of control over tanks 110, 111, and of bin 109 may include but are not limited to temperature control, activation and pump pressure and for bin 109, the activation and speed of conveyor 116.

Liquid binder from tank 110 and, in this example, water from tank 111 are pumped out of their respective tanks through delivery lines 117 and 118 respectively into a pin-mixer 105, which in one embodiment may be a variable-speed mixer. Pin mixer 105 may be one of a variety of pin-mixers known to and available to the inventor. Mixer 105 has a hollow chamber and a shaft extending through the chamber. The shaft has a number of pins welded or otherwise affixed thereto and arranged about the shaft to form the mixing appendages. A motor 108 is provided and connected to mixer 105, more specifically to the mixer shaft. The motor rotates the shaft within the chamber to mix, via the pins, whatever is inside the chamber, in this case binder and water or other suitable solvent. Control station 107 has a control line to pin mixer 105 for activating the mixer and controlling the speed of rotation of the pin mixer. In some embodiments the binder has an ingredient that reacts when it is mixed with water to release a gas like carbon dioxide, and foam may be formed in the process. In one embodiment, this is useful at the point of mixing of the foamed binder with the dry materials to form a more uniform or homogeneous product.

Binder and water, in this example, are simultaneously delivered into pin mixer 105 under pressure. In one embodiment, an air inlet may also be present in mixer 105 so that forced air may be delivered into the mixed product to further aid foaming. In one embodiment, depending on the desired result, a binder with no foaming agent may be used. It is important to note herein that the amounts or rates of introduction of binder and water into pin mixer 105 may be controlled at control station 107 by varying the pump pressure for each tank. Therefore a mix of equal amounts may be undertaken, or a mix of unequal amounts may be undertaken depending on desired results.

Material urged into auto feed bin 103 is further urged from bin 103 through a conduit 102 into a mixing chamber 104 termed a turbo mixer by the inventor. Feed bin 103 has an auger 112 connected at one end of the bin to a motor 101, which rotates auger 112 to urge dry material from the feed bin and through conduit 102 to mixer 104. The rate of feed of dry materials through conduit 102 into turbo mixer 104 in one embodiment is controllable by varying the speed of motor 101 which drives the auger.

Turbo mixer 104 has a rotating shaft 119 substantially centrally located and extending along the length of the chamber. Shaft 119 has a plurality of paddles or blades affixed thereto and arranged along the shaft in a manner that a forward motion is imparted to material in the mixer at the same time that the blades mix the dry material and the incoming premixed liquid or foam material from pin mixer 105. Mixer 104 is driven by a motor 113. Material is thoroughly mixed and moved forward to exit 115, where material may be disposed over, for example, seed trays passing on a conveyor, as described further below.

In summary of the mixing apparatus of the invention, pin mixer 105 driven and controlled by motor 108 premixes the binder liquid and water (or other solvent in some embodiments) and delivers that mixture into turbo mixer 104 through a delivery line 106 under pressure. That pressure may be controlled through control of the supply pressures for the binder and the water. At the same time, dry material enters the turbo mixer 104 from conduit 102. In one embodiment, the premixed binder is foamed in the premix stage and enters mixer 104 as a foam and is immediately mixed with the dry material to produce a substantially homogeneous slurry mixture that is urged out of mixer 104 through egress 115.

Premixing the binder and water in pin mixer 105 provides a more controllable substance for subsequent mixing with dry material. The mixing method used in this example contains an extra mixing operation, but creates a much lighter and more airy product in the case of seed plug materials. The efficiency of system 100 is greater than batch process systems partly because of the continuous feed properties of the system. Likewise the mixing apparatus is linear and continuously operated providing for a more homogeneous mix than a vertical mixer could provide. In a batch process, if conditions are not optimum, one must finish the batch before correcting the situation. In the continuous process of this invention, corrections may be made on-the-fly and continuously, if necessary.

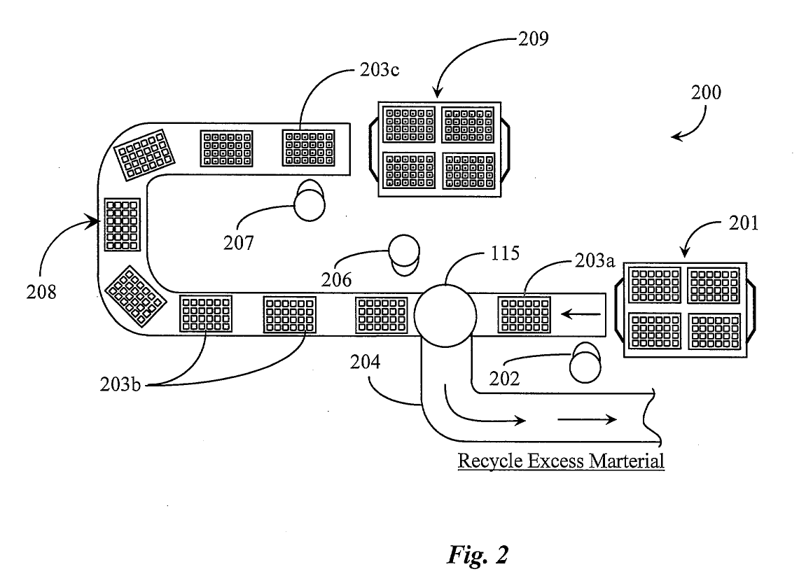

FIG. 2 is a plan overview of a conveyor system 200 for staging containers such as, for example, seed trays for accepting the mixture created by system 100 according to an embodiment of the present invention. Conveyor system 200 is integrated with system 100 described above, and is adapted as a staging means for filling containers with the mixed slurry and removing them from the system for curing.

System 200 comprises a mechanized conveyor 208 that has at least one conveyor belt to propagate the containers along the conveyor. There are a variety of types and designs for conveyor systems, which any number of or combination of may be incorporated in this embodiment without departing from the spirit and scope of the invention. System 200 includes an initial staging end serviced by an attendant 202 having a cart 201 full of empty containers 203a. Attendant 202 places empty containers 203a on the conveyor system and may supervise the filling of each container as it passes under egress 115 of system 100. In some embodiments the distance from the initial end to the filling station is greater, and a second attendant may supervise the actual filling at egress 115.

In preferred embodiments material at egress 115 is flowed over passing containers, and automatic skimmers and the like level the filled containers. In some cases material fills cavities in the containers that are not cavities supposed to be filled, and attendant 206 bumps the containers and scrapes off excess material manually with a paddle. Excess mixture is deposited onto a conveyor path 204 that loops back into the egress point of system 100 therefore being 100% recycled with no waste product.

Filled containers 203b progress on conveyor system 200 until a finished container 203c may be lifted off of conveyor system 208 by an attendant 207 and then placed on a cart or pallet 209 supporting other containers for curing. The finished product may then be allowed to cure for a predetermined period of time before shipping. The exact cure time will depend on the type of process mixture used and the specific end product being produced.

One with skill in the art of automation will appreciate that there may be one or more attendants or no attendants at all depending on the level of automation. For example, automated robots may level, shake and place containers onto waiting carts or onto separate conveyor systems.

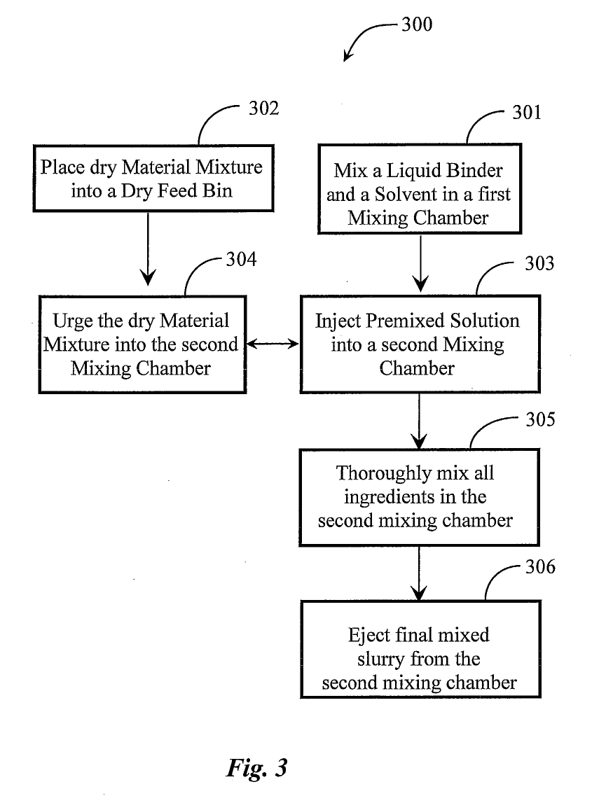

FIG. 3 is a flow chart 300 illustrating a continuous process for mixing ingredients according to an embodiment of the present invention. In step 301, a liquid binder and a solvent are thoroughly mixed in a first mixing chamber. In one embodiment, the liquid binder is a polymer-based binder having a low enough viscosity to be pumped from a tank or vessel. Also in one embodiment, the solvent may be water. In an embodiment using polymer-based binder and water, the binder may react with water to produce a gas like carbon dioxide which promotes foaming.

In step 302, preferably in orchestration with step 301, a dry material is deposited into an auto feed bin analogous to bin 103 of FIG. 1. The dry material may be a mixture available for agricultural purposes having other elements mixed therein like perlite, peat moss, or other such filler or water-retaining materials. At step 303 the premixed solution of binder and water or other solvent is injected under pressure into a second mixing chamber analogous to turbo mixer 104 of FIG. 1. The dry material may be introduced into the second chamber in step 304 via an auger through a connected conduit.

In step 305 the injected premixed material and the dry material are mixed thoroughly in the second mixing chamber via a rotating shaft having mixing blades or paddles attached thereto analogous to shaft 119 of FIG. 1. In step 306, the mixture in the form of homogeneous slurry is ejected from the second mixing chamber and is ready for use. In step 305, the slurry is urged forward by the profile of the blades or paddles attached to the rotating shaft. The rotation of the shaft both mixes the materials and urges the mixture forward and out of the mixer.

The process described above occurs in a continuous fashion such that each step in the process is always running independently of other steps. Moreover, the mixing in both chambers is linear, promoting a more homogeneous mixture of slurry with little or no separation of ingredients and no breakdown of fibers or raw material.

One with skill in the art will appreciate that many aspects of the basic process described herein may be independently controlled to vary consistency and other characteristics of a final mixed product.

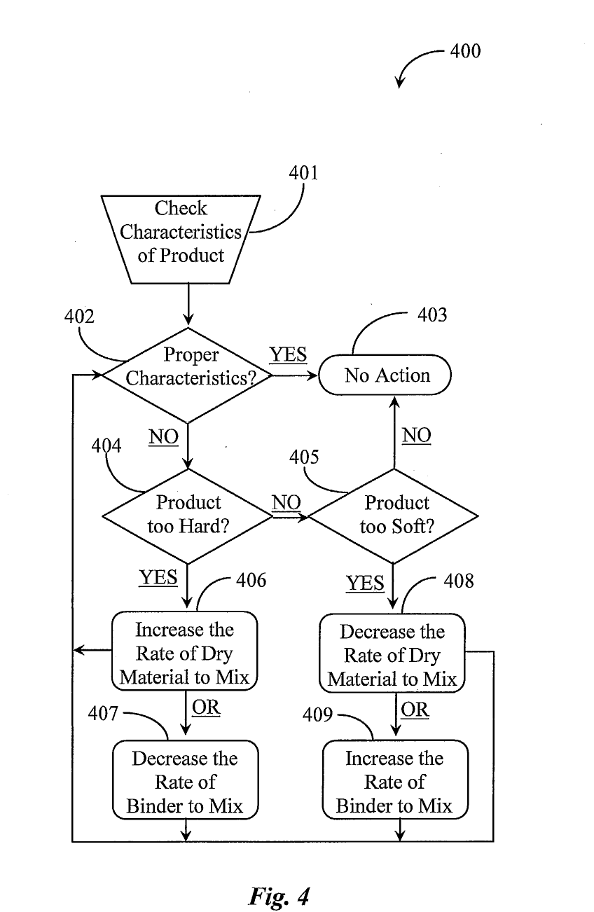

FIG. 4 is a process flow chart 400 for varying characteristics of a product according to an embodiment of the present invention. In step 401, the characteristics of the end product are sampled. In general this step may be performed after a specified time of product curing to determine what the final condition would be when shipped. In one embodiment, however, one with experience running the system may check the consistency of the pre-cured slurry mixture and may determine with some authority the characteristics that will maintain after cure.

In step 402 it is determined whether the characteristics are correct. If correct then no action is taken in step 403. If in step 402 it is determined that the characteristics are not correct for the product, then in step 404 it is determined if the product is too hard. If it is determined in step 404 that the product is not too hard then in step 405 it is determined whether the product is too soft. If in step 405, the determination is that the product is not too soft then the determination made in step 402 was in error and the process resolves back to step 403 where no action need be taken.

If in step 404 it is determined that the product is too hard, then in step 406, the operator may increase the rate of dry material into the final mixing process thereby decreasing the amount of foam or liquid binder mixture. Alternatively, in step 407, the operator may decrease the rate of foam binder or liquid binder mixture injected into the final mixing chamber. In the case of either action 406 or 407, the product may be checked again back at step 402 and the process may repeat from step 402 until the product has the correct characteristics. In step 404 if the product is determined not to be too hard and in step 405 if the product is determined to be too soft, then in step 408 the operator may decrease the rate of dry material fed into the final mixing chamber. Alternatively, the operator may instead increase the rate of binder to mix in step 409. In the case of either action in step 408 or in step 409, the process may loop back to step 402 until the correct characteristics are achieved.

The rate of feed for the dry material into the final mixing chamber can be controlled by increasing or decreasing the rate of rotation of the feed auger urging the material into the final mixer. The rate of injection of the pre-mixed binder solution into the final mixer can be controlled by increasing or decreasing pumping pressure for one or both of the pre-mixed material. The entire process and alternate actions described above may occur during full run of the system without shutting down any part of the system. Likewise, there are other more granular fine tunings that may be undertaken without departing from the spirit and scope of the present invention.

In one aspect, the ratio of binder material to water may be increased or decreased prior to the premixing phase by changing the pumping speed. The same applies to water or other solvents used with the binder. In another aspect, the binder may be caused to have a lower viscosity by increasing the temperature in the binder tank. The speed of the pin mixer may also be increased or decreased to produce more or less foam if a foaming combination of materials is used. Ultimately, the system of the invention may be fine tuned during run to produce the best possible quality product. Those setting may be recorded and repeated for high reliability. Setting up for run of a different product is simple because the optimum settings for that product are record able and repeatable.

It will be apparent to one with skill in the art that the mixing system of the invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention.

The present invention should be afforded the broadest scope under examination. The spirit and scope of the present invention shall be limited only by the following claims.

What is claimed is:

1. A system for producing a mixed slurry, comprising:
a first mixing device for mixing a binder with a solvent, producing a pre-mixed liquid or foam; and
a second mixing device for mixing the premixed liquid or foam with a dry, granular material;
wherein the binder and solvent flow continuously into the first mixing device, the premixed liquid or foam and the dry, granular material flow continuously into the second mixing device, and a competed mixture flows out of the second mixing device.

2. The system of claim 1, wherein the first mixing device is a variable-speed pin mixer.

3. The system of claim 1, wherein the second mixing device is a linear mixer having a mixing chamber and a rotable shaft with mixing paddles attached thereto in a manner to impart a forward motion to the material being mixed.

4. The system of claim 1, wherein the liquid binder is a polymer-based binder including a foaming agent.

5. The system of claim 1, wherein the liquid binder is reactive with water to release gas, producing foam.

6. The system of claim 1, wherein the dry material and binder mixture are introduced to the second mixing device simultaneously and continuously during system run time.

7. The system of claim 1 further including an automatic feed bin having a rotable auger disposed therein for feeding the dry material into the second mixing device.

8. The system of claim 7 further including a control station for controlling the speeds of the first mixing device and the second mixing device.

9. The system of claim 8 further including a first source tank for storing the liquid binder and a first pump controllable at the control station for pumping the liquid binder out of the first source tank into the first mixing device.

10. The system of claim 9 further including a second source tank for storing the fluid and a second pump controllable at the control station for pumping the fluid out of the second source tank into the first mixing device.

11. The system of claim 10, further including a source bin for storing the dry material and a conveyor system controllable at the control station for conveying the dry material from the source bin to the automatic feed bin.

12. A method for mixing a dry material with a liquid binder comprising the steps of:
(a) pumping the liquid binder and a solvent from separate source tanks into a first mixing device;
(b) mixing the liquid binder and fluid within the first mixing device;
(c) feeding the dry material and injecting the premixed binder into a second mixing device; and
(d) mixing the dry material and the premixed binder within the second mixing device.

13. The method of claim 12, wherein in step (a), the liquid binder is a polymer and the fluid is water.

14. The method of claim 13, wherein the liquid binder reacts with water to produce a gas, causing foaming.

15. The method of claim 12, wherein in step (b), the first mixing device is a pin mixer.

16. The method of claim 12, wherein in step (a) the liquid binder is temperature controlled.

17. The method of claim 12, wherein in step (b), the speed of mixing and the pressure within the mixer is controllable at a control station.

18. The method of claim 12, wherein in step (c) the rate of feed of the dry material is controllable at a control station.

19. A system for producing seed plugs, comprising:
a conveyor moving seed trays continuously past a fill point; and
an apparatus producing a mixed slurry having a first mixing device mixing a binder with a solvent, producing a pre-mixed liquid or foam feeding into a second mixing device mixing the premixed liquid or foam with a dry, granular material, producing a homogeneous mixture flowing over trays on the conveyor at the fill point.

20. The system of claim 19 wherein the conveyor extends a distance beyond the fill point, allowing the homogeneous mixture to at least partially cure. _
